(19) United States
(12) Patent Application Publication
(10) Pub. No.: US 2011/0148792 A1
(43) Pub. Date: Jun. 23, 2011

(54) POINTING AND DISPLAY SYSTEM WITH DISPLAY TILT-ADJUSTING FUNCTION AND ASSOCIATED ADJUSTING METHOD

(75) Inventors: YING-MING HWANG, Taipei (TW); TZUNG-LIN LEE, Taipei (TW); FENG-CHANG HSU, Taipei (TW)

(73) Assignee: AVERMEDIA INFORMATION, INC., Taipei (TW)

(21) Appl. No.: 12/974,345

(22) Filed: Dec. 21, 2010

(30) Foreign Application Priority Data
Dec. 22, 2009 (TW) 098144296

(51) Int. Cl. G06F 3/041

(52) U.S. Cl. 345/173

(57) ABSTRACT

A display tilt-adjusting method is used between a pointing device and a display device. Firstly, first moving information is acquired in response to a movement of the pointing device. Then, error information is acquired according to the first moving information. According to the error information, the first moving information is transformed into second moving information. Afterwards, a moving path corresponding to the movement of the pointing device is shown on the display device according to the second moving information.

### FIELD OF THE INVENTION

The present invention relates to a pointing and display system with display tilt-adjusting function and associated adjusting method, and more particularly to a pointing and display system which corrects display tilt by a software control method.

### BACKGROUND OF THE INVENTION

In a computer system, a pointing device such as a mouse or a pen mouse is used for controlling a cursor on a display device. It is easy to use such pointing device to select or point to an object on the display device. However, the performance of the pointing device in drawing or writing is usually unsatisfied because the operation of the pointing device should meet a strict precision requirement. Since the hand-eye coordination and manipulating habit of different users are different, the holding angle of the pointing device for different users also varies. In other words, the cursor-moving path shown on the display device is different from the moving path expected by the user.

When a pen is used to write or draw on a paper sheet, the tip contact surface and the paper sheet are coplanar. On the other hand, when the pointing device (e.g. a mouse or a pen mouse) is used to control the cursor moving on the display device, the surface supporting the pointing device and the display device are not coplanar. That is, the movement of the pointing device is not exact the cursor movement. As such, it is necessary for the user to correlate the movement of the pointing device with the cursor movement. However, it is apparent that the results of correlation are different among different users.

Hereinafter, the deviation between the real image drawn via a pointing device and the ideal image will be illustrated with reference to FIG. 1. FIG. 1A is a schematic diagram illustrating an ideal image which should be shown on the display device. Ideally, the tree 101 drawn via a pointing device and shown on the display device should be upright. Since it is almost impossible for the user to always write or draw in an absolutely “correct” direction, the tree 101 shown on the display device is deviated from the reference coordinate system of the display device. That is, as shown in FIG. 1B, the user basis (e.g. x′-y′ coordinate system) shown on the display device is deviated from the standard basis (i.e. the x-y coordinate system) of the display device by a deviation angle θ. In other words, the real image tilts. For different users and different pointing devices, the deviation angle θ varies. For example, there is a deviation angle θ1 between the user basis and the standard basis for a user A; but there is another deviation angle θ2 between the user basis and the standard basis for a user B.

Generally, the deviation angle between the user basis and the standard basis is manually corrected. In other words, the user has to repeatedly adjust angle/position of the wrist or elbow to conform to the standard basis. The manual correcting method is neither user-friendly nor ergonomic. Otherwise, to prevent the deviation or tilt, the user may use a drawing tablet. By referring to the edge of the drawing tablet, it becomes easier to draw or write in a precise direction to meet the standard basis. Although the use of the drawing tablet may correct the deviation or tilt, there are still some drawbacks. For example, since the size of the drawing tablet is much bulkier than the ordinary pointing device, the use of the drawing tablet is inconvenient.

From the above discussions, the conventional method for correcting the deviation angle between the user basis and the standard basis is usually unsatisfied. Although the use of the drawing tablet may correct the deviation angle, another problem occurs. Therefore, there is a need of providing a device for correcting the deviation angle.

### SUMMARY OF THE INVENTION

In accordance with an aspect, the present invention provides a display tilt-adjusting method for use between a pointing device and a display device. Firstly, first moving information is acquired in response to a movement of the pointing device. Then, error information is acquired according to the first moving information. According to the error information, the first moving information is transformed into second moving information. Afterwards, a moving path corresponding to the movement of the pointing device is shown on the display device according to the second moving information.

In accordance with another aspect, the present invention provides a pointing and display system. The pointing and display system includes a pointing device and a display device. The pointing device is used for acquiring first moving information in response to a movement of the pointing device, and transforming the first moving information into second moving information according to error information. The display device is in communication with the pointing device for showing a moving path corresponding to the movement of the pointing device according to the second moving information.

In accordance with a further aspect, the present invention provides a pointing and display system. The pointing and display system includes a pointing device and a display device. The pointing device is used for acquiring first moving information in response to a movement of the pointing device. The display device is in communication with the pointing device for receiving the first moving information, transforming the first moving information into second moving information according to error information, and showing a moving path corresponding to the movement of the pointing device according to the second moving information.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a schematic diagram illustrating an ideal image drawn by a pointing device;

FIG. 1B is a schematic diagram illustrating the deviation of real image from a reference coordinate system of the display screen;

FIG. 2 is a schematic functional block diagram illustrating a pointing and display system according to an embodiment of the present invention;

FIG. 3A is a schematic diagram illustrating a first moving path shown on a display device in response to a movement of the pointing device and a standard basis of the display device;

FIG. 3B is a schematic diagram illustrating the first moving path and a user basis;

FIG. 3C is a schematic diagram illustrating the first moving path, the standard basis and the user basis;

FIGS. 4A and 4B are schematic diagram illustrating a method of transforming the moving information according to an embodiment of the present invention;

FIG. 5 is a flowchart of a display tilt-adjusting method according to the present invention;

FIG. 6A is a schematic functional block diagram illustrating a pointing and display system according to a first embodiment of the present invention; and

FIG. 6B is a schematic functional block diagram illustrating a pointing and display system according to a second embodiment of the present invention.

### DETAILED DESCRIPTION OF THE PREFERRED EMBODIMENT

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

As previously described in the prior art, when the moving path of the pointing device is shown on the display device, a tilt usually occurs. For obviating the drawbacks encountered in the prior art, the present invention provides a software control method for use with a display device and a pointing device for correcting display tilt by converting the moving information.

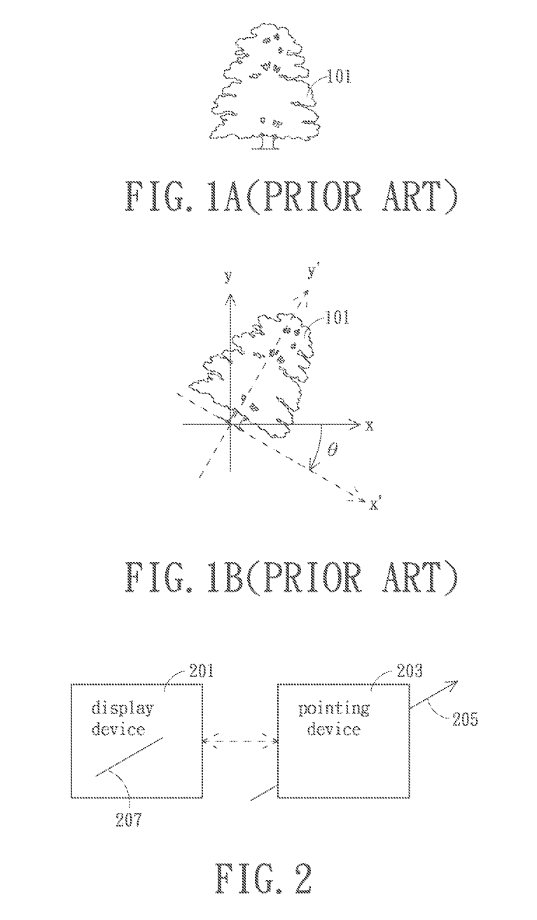

FIG. 2 is a schematic functional block diagram illustrating a pointing and display system according to an embodiment of the present invention. As shown in FIG. 2, the pointing and display system includes a display device 201 and a pointing device 203. The display device 201 and the pointing device 203 are in communication with each other according to a wireless transmission technology (e.g. IR, Bluetooth or wireless network) or a wired transmission technology (e.g. data line or cable line). An example of the display device 201 includes but is not limited to a screen or a personal computer. An example of the pointing device 203 includes but is not limited to an optical mouse, a mechanical mouse, a pen mouse or a trackball. In response to a movement (indicated by arrow 205) of the pointing device 203, associated moving information is acquired and transmitted to the display device 201. As such, a first moving path 207 corresponding to the moving information is shown on the display device 201.

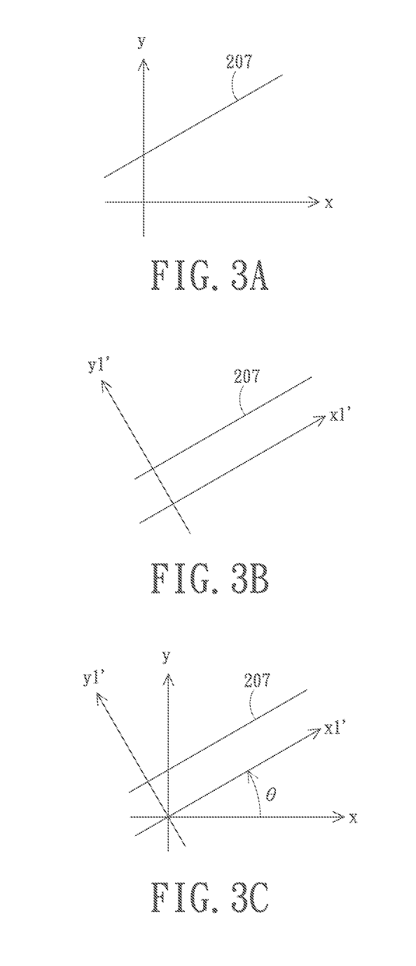

FIG. 3A is a schematic diagram illustrating the first moving path 207 shown on the display device 201 in response to the movement of the pointing device 203 and a standard basis of the display device 201. The standard basis of the display device 201 is represented by an x-y coordinate system. The first moving path 207 is a track shown on the display device 201 in response to the movement of the pointing device 203. Due to the holding angle of the pointing device 203 and the manipulating habit, the pointing device 203 may be slightly rotated or the sensor within the pointing device 203 is deviated. For example, even if the user thinks that the pointing device 203 is moved in a horizontal direction, the moving information received by the display device 201 may indicate a slant line. In other words, there is a deviation angle between the user basis and the standard basis (i.e. the x-y coordinate system).

FIG. 3B is a schematic diagram illustrating the first moving path 207 shown on the display device 201 and the user basis. As shown in FIG. 3B, the use basis is represented by an x1′-y1′ coordinate system. If the first moving path 207 is shown with respect to the user basis, the first moving path 207 is substantially a horizontal line.

FIG. 3C is a schematic diagram illustrating the first moving path 207, the standard basis and the user basis. As shown in FIG. 3C, the operation of the pointing device 203 complies with the user basis (i.e. x1′-y1′ coordinate system). The x1′-y1′ coordinate system is deviated from the standard basis (i.e. the x-y coordinate system) by a deviation angle θ. After the deviation angle θ is offset, the first moving path 207 can be correctly shown on the display device 201.

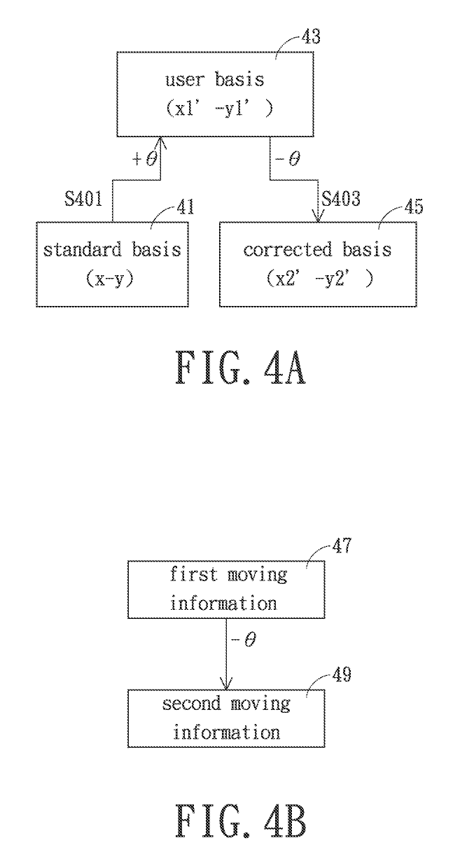

FIGS. 4A and 4B are schematic diagrams illustrating a method of transforming the moving information according to an embodiment of the present invention. The method may change the direction of the first moving path. As shown in FIGS. 3C and 4A, there is error information (e.g. the deviation angle +θ) between the user basis 43 and the standard basis 41. By comparing the user basis 43 (i.e. x1′-y1′ coordinate system) with the standard basis 41 (i.e. the x-y coordinate system), the error information is acquired (Step S401). After the error information (e.g. the deviation angle +θ) between the user basis 43 and the standard basis 41 is acquired, an offset procedure is done to rotate the user basis 41 by a reverse deviation angle (i.e. −θ), so that the user basis 43 (i.e. the x1′-y1′ coordinate system) is transformed to a corrected basis 45 (i.e. the x2′-y2′ coordinate system) (Step S402).

After the offset procedure is done to rotate the user basis 41 by the reverse deviation angle (−θ), the first moving information 47 in response to the movement of the pointing device 203 is transformed into the second moving information 49.

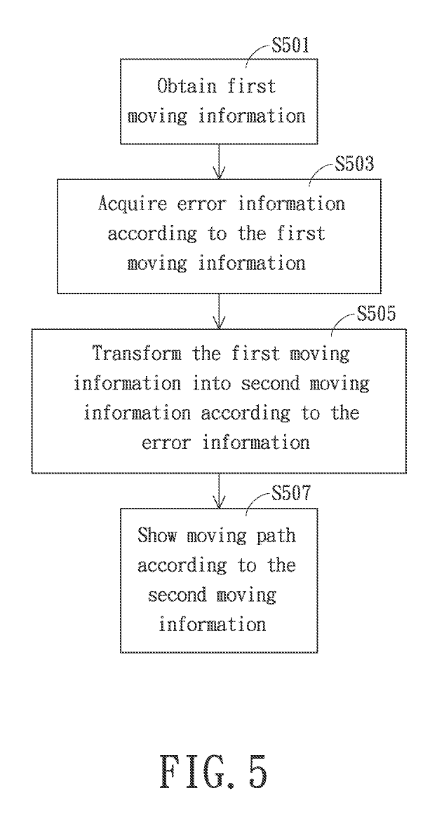

FIG. 5 is a flowchart of a display tilt-adjusting method according to the present invention. First of all, in the step S501, first moving information 47 is obtained in response to a movement of the pointing device 203, and a user basis (i.e. the x1′-y1′ coordinate system) is obtained according to the first moving information 47. Then, in the step S503, error information is acquired according to a difference between the standard basis 41 and the user basis 43. Then, in the step S505, according to the error information, the first moving information 47 is transformed into second moving information 49. After the first moving information 47 is transformed into the second moving information 49 according to the error information, the method goes to step S507. In the step S507, a moving path is shown on the display device 201 according to the second moving information 49. The subsequent moving information (first moving information) will be transformed into corrected moving information (second moving information) continuously according to the error information to correct display tilt phenomenon.

For further understanding the effect of the present invention, the transformation between the original moving information and the corrected moving information will be illustrated in more details with reference to FIGS. 2, 3 and 4. Generally, the display device 201 has a standard basis 41 (e.g. the x-y coordinate system).

In response to a movement of the pointing device 203, a first moving path corresponding to the first moving information 47 is shown on the display device 201. According to the first moving path (or the first moving information 47), a user basis 43 (i.e. the x1′-y1′ coordinate system) is obtained.

According to the standard basis 41 of the display device 201 and the user basis 43 obtained by manipulating the pointing device 203, the error information is acquired to denote the difference between the real operating basis 43 (i.e. the x1′-y1′ coordinate system) and the ideal standard basis 41 (i.e. the x-y coordinate system). According to the error information, the first moving information 47 is transformed into the second moving information 49. Moreover, according to the error information, the pointing device 203 or the display device 201 of the pointing and display system can be optionally used to achieve data-mapping.

After the error information is acquired, the offset procedure is done to adjust the relation between the movement of the pointing device 203 and the cursor movement shown on the display device 201 according to the error information. In other words, when the pointing device 203 is moved, an application program installed in the pointing device 203 or the display device 201 transforms the original first moving information 47 into the second moving information 49. The second moving information 49 complies with the corrected basis 45 (i.e. the x2′-y2′ coordinate system) which is substantially consistent with the standard basis 41 (e.g. the x-y coordinate system) of the display device 201. That is, the cursor movement is controlled according to the second moving information 49 rather than the original first moving information 47.

In the above embodiments, the first moving information 47 is transformed into the second moving information 49 when the pointing device 203 is operated, and the moving path or the cursor movement is shown according to the second moving information 49. The transformation continues as long as the pointing device 203 is used. For example, in response to another movement of the pointing device 203, third moving information is acquired. In the same way described above, the third moving information is transformed into fourth moving information according to the error information. Then, the moving path or cursor movement corresponding to the movement of the pointing device 203 is shown according to the fourth moving information.

The sequence of transforming the moving information may be varied according to the practical requirements. For example, in some embodiments, the step of showing the moving path corresponding to the movement of the pointing device 203 according to the second moving information 49 and the fourth moving information is performed after the step of transforming the first moving information 47 into the second moving information 49 and the step of transforming the third moving information into the fourth moving information. Alternatively, the step of showing the moving path corresponding to the movement of the pointing device 203 according to the second moving information 49 is performed after the step of transforming the first moving information 47 into the second moving information 49 according to the error information; and the step of showing the moving path corresponding to the movement of the pointing device 203 according to the fourth moving information is performed after the step of transforming the third moving information into the fourth moving information according to the error information.

The steps of transforming the first moving information into the second moving information and showing the moving path corresponding to the movement of the pointing device 203 on the display device 201 in real-time when the pointing device 203 is manipulated by the user. Alternatively, in some embodiments, after the pointing device 203 is manipulated for a period, the moving information transformation and corresponding showing steps are implemented by the application program or associated software.

For further understanding the script of the present invention, the data transforming process will be illustrated as follows.

The first moving information 47 denotes the movement of the pointing device 203. For example, the tilted tree 101 shown in FIG. 1B of a test horizontal/vertical line denotes the first moving information 47. The user basis 43 (i.e. the x1′-y1′ coordinate system) is acquired according to the first moving information 47. On the other hand, the standard basis 41 of the display device 201 denotes the x-y coordinate system. By comparing the standard basis 41 with the user basis 43, the error information (i.e. the deviation angle θ in a clockwise direction) is acquired. After the error information is acquired, when the first moving information 47 is acquired in response to the movement of the pointing device 203, an offset procedure is done to rotate the first moving information 47 by the deviation angle θ in a counterclockwise direction. In such way, the second moving information is acquired.

In other words, according to the error information, the second moving information 49 may be acquired during the use of the pointing device 203. In such way, the purpose of correcting the display tilt is achieved, and the corrected image complies with the standard basis (i.e. x-y coordinate system).

The above description focuses on the transformation between various moving information. It is to be noted that numerous modifications and alterations may be made while retaining the teachings of the invention. For example, in some embodiments, the moving information transformation is performed by the pointing device 203 and the moving path corresponding to the movement of the pointing device 203 is shown on the display device 201. In this embodiment, the pointing and display system only includes the pointing device 203 and the display device 201. In some embodiments, the pointing and display system may further include a transformation device for performing the moving information transformation.

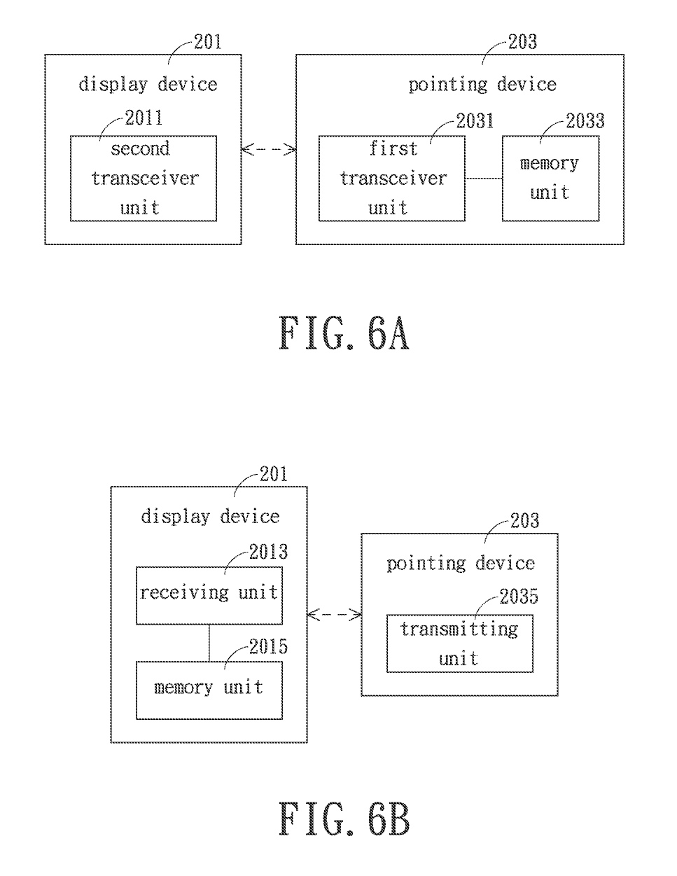

FIG. 6A is a schematic functional block diagram illustrating a pointing and display system according to a first embodiment of the present invention. As shown in FIG. 6A, the pointing and display system includes a display device 201 and a pointing device 203. The display device 201 and the pointing device 203 are in communication with each other. The pointing device 203 includes a first transceiver unit 2031 and a memory unit 2033. The first transceiver unit 2031 is used for transmitting the first moving information 47 to the display device 201, receiving the error information from the display device 201, and transmitting the second moving information 49 to the display device 201. The memory unit 2033 is used for recording the error information associated with the operation of the pointing device 203 and related controlling procedures. Corresponding to the first transceiver unit 2031, the display device 201 includes a second transceiver unit 2011. The second transceiver unit 2011 is used for receiving the first moving information 47 from the pointing device 203, transmitting the error information to the pointing device 203 and receiving the second moving information 49 from the pointing device 203.

A data transmission mechanism between the first transceiver unit 2031 and the second transceiver unit 2011 will be illustrated as follows. Firstly, by sensing the movement of the pointing device 203, the pointing device 203 acquires the first moving information 47. Then, according to the standard basis 41 of the display device 201 and the user basis 43 obtained from the pointing device 203, the error information is obtained. According to the error information, the first moving information 47 is transformed into the second moving information 49. Afterwards, the moving path corresponding to the movement of the pointing device 203 is shown on the display device 201 according to the second moving information 49.

In this embodiment, after the error information is acquired by the display device 201 and transmitted to the pointing device 203, the moving information transformation is performed by the pointing device 203. Moreover, the transforming step and the comparing step may be performed by an application program installed in the memory unit 2033 (e.g. a non-volatile memory such as a flash memory).

In the pointing and display system of FIG. 6A, the pointing device 203 is responsible for the moving information transformation. In some embodiments, the display device 201 is responsible for the moving information transformation.

FIG. 6B is a schematic functional block diagram illustrating a pointing and display system according to a second embodiment of the present invention. In this embodiment, the pointing device 203 includes a transmitting unit 2035, and the display device 201 includes a receiving unit 2013 and a memory unit 2015. Via the transmitting unit 2035 and the receiving unit 2013, the display device 201 and the pointing device 203 are in communication with each other according to a wireless transmission technology (e.g. IR, Bluetooth or wireless network) or a wired transmission technology (e.g. data line or cable line). The memory unit 2015 stores therein the application program for performing some steps of the display tilt-adjusting method of the present invention. In practice, the memory unit 2015 may be disposed in the pointing device 203 or the display device 201.

A data transmission mechanism between the pointing device 203 and the display device 201 will be illustrated as follows. Firstly, by sensing the movement of the pointing device 203, the pointing device 203 acquires the first moving information 47. The subsequent steps are performed by the display device 201. After the first moving information 47 transmitted from the pointing device 203 is received by the display device 201, the error information is acquired according to the first moving information 47. For example, the error information is acquired by comparing the user basis 43 with the standard basis 41 of the display device 201 wherein the first moving information 47 complies with the user basis 43. Alternatively, the display device 201 provides reference moving information to be compared with the first moving information 47 to acquire the error information. Then, according to the error information, the first moving information 47 is transformed into the second moving information 49. Afterwards, the cursor movement corresponding to the movement of the pointing device 203 is shown on the display device 201 according to the second moving information 49. As such, the purpose of correcting the display tilt is achieved.

In the second embodiment, the moving information transformation is principally performed by the display device 201. The transmitting unit 2035 of the pointing device 203 is used for transmitting the first moving information 47 to the receiving unit 2013 of the display device 201. The subsequent steps (e.g. transformation of the first moving information 47, acquiring the user basis 43, comparison between the reference moving information with the first moving information 47, and so on) may be implemented by an application program (e.g. training program) in the memory unit 2015 of the display device 201. Furthermore, the memory unit 2015 can record the error information for respective user to achieve the auto-adjusting function.

The process of acquiring the standard basis 41 according to the reference coordinate system of the display device 201 and the process of comparing the standard basis 41 with the first moving information 47 may be performed by an application program (e.g. a training program). For complying with the usual practice of individual user, the offset angle may be recorded in the memory unit.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display tilt-adjusting method for use between a pointing device and a display device, comprising steps of:
acquiring first moving information in response to a first movement of the pointing device;
acquiring error information according to the first moving information;
transforming the first moving information into second moving information according to the error information; and
showing a first moving path corresponding to the first movement of the pointing device on the display device according to the second moving information.

2. The display tilt-adjusting method according to claim 1 wherein the first moving information complies with a user basis, the display device has a standard basis, and the error information is obtained according to the user basis and the standard basis.

3. The display tilt-adjusting method according to claim 2 wherein the second moving information complies with a corrected basis which is more consistent with the standard basis than the user basis.

4. The display tilt-adjusting method according to claim 1 wherein the error information is obtained according to the first moving information provided by the pointing device and reference moving information provided by the display device.

5. The display tilt-adjusting method according to claim 1, further comprising steps of:
acquiring third moving information in response to a second movement of the pointing device;
transforming the third moving information into fourth moving information according to the error information; and
showing a second moving path corresponding to the second movement of the pointing device on the display device according to the fourth moving information.

6. A pointing and display system, comprising:
a pointing device for acquiring first moving information in response to a movement of the pointing device, and transforming the first moving information into second moving information according to error information; and
a display device in communication with the pointing device for showing a moving path corresponding to the movement of the pointing device according to the second moving information.

7. The pointing and display system according to claim 6 wherein the first moving information complies with a user basis, the display device has a standard basis, and the error information is obtained according to the user basis and the standard basis.

8. The pointing and display system according to claim 6 wherein the second moving information complies with a corrected basis which is more consistent with the standard basis than the user basis.

9. The pointing and display system according to claim 6 wherein the error information is obtained according to the first moving information provided by the pointing device and reference moving information provided by the display device.

10. The pointing and display system according to claim 6 wherein an application program is installed in the pointing device and executed to transform the first moving information into the second moving information.

11. The pointing and display system according to claim 6 wherein the pointing device comprises:
a first transceiver unit for transmitting the first moving information to the display device, receiving the error information from the display device and transmitting the second moving information to the display device; and
a memory unit for recording the error information.

12. The pointing and display system according to claim 6 wherein the display device comprises a second transceiver unit for receiving the first moving information from the pointing device, transmitting the error information to the pointing device and receiving the second moving information from the pointing device.

13. The pointing and display system according to claim 6 wherein the pointing device is an optical mouse, a mechanical mouse, a pen mouse or a trackball, and the display device is a screen or a personal computer, wherein the pointing device and the display device are in communication with each other according to a wireless transmission technology or a wired transmission technology.

14. A pointing and display system, comprising:
a pointing device for acquiring first moving information in response to a movement of the pointing device; and
a display device in communication with the pointing device for receiving the first moving information, transforming the first moving information into second moving information according to error information, and showing a moving path corresponding to the movement of the pointing device according to the second moving information.

15. The pointing and display system according to claim 14 wherein the first moving information complies with a user basis, the display device has a standard basis, and the error information is obtained according to the user basis and the standard basis.

16. The pointing and display system according to claim 14 wherein the second moving information complies with a corrected basis which is more consistent with the standard basis than the user basis.

17. The pointing and display system according to claim 14 wherein the error information is obtained according to the first moving information provided by the pointing device and reference moving information provided by the display device.

18. The pointing and display system according to claim 14 wherein an application program is installed in the pointing device and executed to transform the first moving information into the second moving information.

19. The pointing and display system according to claim 14 wherein the pointing device comprises:
a transmitting unit for transmitting the first moving information to the display device; and
a memory unit for recording the error information, and the display device comprises:
a receiving unit for receiving the first moving information from the pointing device.

20. The pointing and display system according to claim 14 wherein the pointing device is an optical mouse, a mechanical mouse, a pen mouse or a trackball, and the display device is a screen or a personal computer, wherein the pointing device and the display device are in communication with each other according to a wireless transmission technology or a wired transmission technology.
